(19) United States
(12) Patent Application Publication
(10) Pub. No.: US 2015/0153553 A1
(43) Pub. Date: Jun. 4, 2015

(54) FLUORESCENCE OBSERVATION DEVICE, DOMED BASE AND FLUORESCENCE MICROSCOPE PROVIDED WITH PARTITION DOME

(71) Applicant: Lumos Technology Co., Ltd., Taipei (TW)

(72) Inventor: Chih-Yi Yang, Taipei (TW)

(73) Assignee: Lumos Technology Co., Ltd., Taipei (TW)

(21) Appl. No.: 14/060,527

(22) Filed: Oct. 22, 2013

(30) Foreign Application Priority Data
Oct. 22, 2012 (CN) 201210402919.4
Oct. 22, 2012 (CN) 201210402931.5
Jun. 20, 2013 (CN) 201310248201.9

(51) Int. Cl. G02B 21/00

(52) U.S. Cl. CPC G02B 21/0076

(57) ABSTRACT

A fluorescence observation device with a partition dome, provided for confining and observing the movement of the fluorescent object, consisting of: a base formed with a predetermined observation site; a dome coupled to and covering the base to define a light-shielding chamber and formed with a transparent observation aperture; and a light source assembly including a plurality of light sources for emitting excitation light at low angles towards the predetermined observation site.

### BACKGROUND OF THE INVENTION

1. Field of the Invention

The present invention is related to a fluorescence observation device with a partition dome, base and fluorescence microscope for the purpose of fluorescence observation.

2. Description of Related Art

In addition to its existing applications in industrial inspection, counterfeit identification and criminal identification, the fluorescence microscopy device has expanded to cell analysis and tracking in biological research in recent years, which gradually highlights the importance of image acquisition of the fluorescence microscopy. Gene transplant is a critical research in the biotech field. For the convenience of observation, the transplanted gene usually produces fluorescent protein, so the transplanted gene can be tracked by observing the fluorescence reaction of the object. Generally, the experimental fluorescent object is with high re-productivity and short reproduction cycle, which can reproduce a great deal of offspring rapidly and has an organ system similar to that of humans. It is mainly applied in researches related to disease, drug screening and toxicity test.

As for the fluorescence here, it mainly refers to the relatively low-frequency fluorescence produced by emitting high-frequency light on the fluorescent object, such as the anti-counterfeit banknote, or the position with suspicious bloodstain on the criminal scene. Together with the appropriate filter lens combination, the fluorescence image of the above banknote or bloodstain can be clearly observed or acquired. When it is applied on many researches on gene transplant in the biotech field, for the convenience of observation, the transplanted gene usually produces fluorescent protein to observe the fluorescent reaction of the object, so as to confirm the results of gene transplant and conduct further research on the object with a successful transplant.

At present, the common fluorescent living things include the white mice, maggots, many kinds of fish, jellyfish, etc., which greatly vary in physical size or wave length of the produced excitation fluorescence. Generally, it is difficult to confine the movement of the animals that are large in size or visible to the naked eyes. Especially for the fluorescent objects with strong activity such as the white mouse, they might lick or bite the observation device, causing blurriness or scratches on the lens. In addition, since the the experimental white mouse produce saliva and waste, which are media for spreading germs. On the other hand, the observation space has to be used repeatedly, thus the cleaning and sterilization of the observation device present another problem.

Therefore, the problem of confining its movement and provide an economical and easy-to-operate aided instrument for the convenience of observation, must be resolved prior to the experiment. Even if the experimental white mouse is fed in the animal center, due to its strong re-productivity and activity, the fluorescent reaction is needed to be analyzed and confirmed since it is picked up for experiment. Therefore, a light, portable, easy-to-clean and sterilize fluorescence observation device is needed.

Zebrafish with its fluorescent gene has been massively researched in recent years, because this kind of zebrafish has high re-productivity and short reproduction cycle, which can reproduce a great deal of offspring and has organ system similar to that of humans. It has even been used in researches related to disease, drug screening and toxicity test. However, if the experimental object is the zebrafish as small as sesame, it needs to be observed and recorded by using a microscope with different magnification capacity. The fluorescence microscope commonly used at present, can assist the researchers in observing the objects with fluorescent reaction conveniently. However, the major manufacturers of fluorescence microscopes lead the optics manufacturing industry, and they mainly focus on how to restrain the direction of the excitation light beam, so as to increase the resolution and reduce errors of the image theoretically. Consequently, the structure is still based on the major optical design of the old microscope.

Unfortunately, when the excitation light beam goes through a long distance, the power is dispersed and weakened with inverse distance square. To resolve the insufficient power of the excitation light beam when reaching the observation object, the current fluorescence microscope greatly increases the luminance of the light source, causing protein denaturation of the tiny observation object such as the zebrafish due to overheating during the observation process. Furthermore, since the excitation light is directly emitted on the surface of the observation object from a vertical direction, it will produce a strong reflection light, and the fluorescence released after absorbing excitation light is less intense than that of the direct reflection light. Namely, the reflection light with short wave length that is taken as noise is a thousand times more intense, than that of the actually observed and recorded fluorescence signal with longer wave length. Due to the poor S/N ratio, it requires expensive optical structure equipped with extremely complicated configuration, so the fluorescence microscope is far more expensive than the ordinary microscope.

Most especially, the existing fluorescence microscope is incompatible with the ordinary microscope, it forces the observers of fluorescent reaction to give up the current microscope in the laboratory. They have to purchase the expensive fluorescence microscope, which is against the general expectation. Moreover, the price of a microscope is highly correlated to its performance, which is greatly influenced by the number of lenses and manufacturing process. If an ordinary optical microscope with high performance has been already purchased, it is hard or impossible to purchase another high-performance fluorescence one. Therefore, how to change the ordinary optical microscope into a fluorescence one highlighting the fluorescence feature becomes the key point of research in this case.

For the convenience of analysis and observation, the present fluorescence related experiments usually adopt blue or green fluorescent protein released by ultraviolet or deep-blue light. Therefore, an existing aided device uses two bellow tubes to dispose the ultraviolet or deep-blue light source in the front, so the user can bend and rotate the bellow tubes to illuminate the fluorescent object from an appropriate angle, so as to produce light. However, when the objective of optical microscope is only 2 or 3 cm away from the object, it is hard for the bellow to bend given the small space due to its size. Thus, it is unable to conduct precision adjustment. It will cause the problems of wrong emitting angle, and uneven luminance within the illumination range, as a result, the acquired image can't be analyzed precisely and quantitatively.

This type of bellow tube is quite unfavorable to the above biological experiment especially since the luminance and temperature exert great impact on the fluorescent object. When conducting the above fluorescence microscope experiment, on one hand, the fluorescent object such as the zebrafish or maggots might keep moving. On the other hand, the zebrafish in the water drop might die during the experiment due to the insufficient oxygen content in the water drop. Therefore, the influence exerted from the general experimental environment must be considered, such as operation time and heat of light source on the object. Moreover, the uneven illumination in a small range is harder to obtain stable data, which might increase experimental time. If you are unfamiliar with the operation or if you are unfortunate, the experiment might fail easily.

Therefore, a fluorescence observation device with features of even illumination, convenient and fast operation, should be selected for use, so that the researcher won't be distracted in operating the light source and shield the external interference light appropriately, making the experimental process smooth and easy to observe and record, and finishing the experimental research within the limited lifespan of the object on the support tray. This makes the experiment faster, and at the same time, it also improves the quality of experimental research and increases the successful probability.

In summary, the invention attempts to provide a better fluorescence observation device with a partition dome, base and fluorescence microscope. By confining the movement of the fluorescent object, it restrains the object for the convenience of observation. By maintaining the safety distance between the fluorescent object and observation device, it quarantines the contamination and prevents scratches. With the removable parts, it facilitates cleaning and sterilization. In the meantime, it easily changes the ordinary microscope or microscope camera to meet the requirements of fluorescence research. Moreover, while simplifying the structure and increasing operational convenience, the quality of the microscope observation and recording is not affected. It also proposes a stable and simple operation platform, which can satisfy various experimental application demands at an affordable price, making it possess an incomparable price-performance ratio.

### SUMMARY OF THE INVENTION

The purpose of the present invention is to provide a portable and removable fluorescence observation device with a partition dome, which can be cleaned conveniently by the researchers, enhancing the convenience of use.

Another purpose of the invention is to provide a fluorescence observation device with a partition dome formed with an isolated space, so the fluorescent object will never get out of the observation scope. In this way, it increases the successful probability of the experimental research, and reduces the possibility of spreading germs or pollutants.

Another purpose of the invention is to provide a fluorescence observation device with a partition dome to shield the interference of external strong light and noise light, so as to improve the quality of fluorescence microscope imaging.

Another purpose of the invention is to provide a fluorescence observation device with a partition dome with transparent lid, so as to prevent direct contact between the fluorescent object and observation lens.

Another purpose of the invention is to provide a fluorescence observation device with a partition dome with light source assembly at low angles featured by low power and short illumination distance to concentrate light beam, so as to improve S/N ratio of fluorescence observation.

Another purpose of the invention is to provide a more economical base. Installed with the fluorescence observation device with a partition dome, the base can be easily compatible with the present optical microscope, so as to change the ordinary optical microscope into fluorescence microscope.

Another purpose of the invention is to provide a more economical fluorescence microscope. It is equipped with dome not only to shield the interference of the external strong light and noise light, so as to improve the quality of fluorescence microscope imaging, but also to prevent direct contact between the fluorescent object and observation lens.

It is still another purpose of the invention to provide a more economical fluorescence microscope. It has a light source assembly at low angles featured by low power and short illumination distance to concentrate light beam, so as to improve S/N ratio of fluorescence observation.

To achieve the above purposes, the fluorescence observation device with a partition dome in the invention is for confining and observing the movement of one fluorescent object. The fluorescence observation device consists of: a base formed with a predetermined observation site; a dome coupled to and covering the base to define a light-shielding chamber and formed with a transparent observation aperture; and a light source assembly consisting of a plurality of light sources for emitting excitation light at low angles towards the predetermined observation site.

Assembling the above fluorescence observation device with a partition dome on the base will form a domed base with a partition dome for use in the microscope in this invention, for confining and observing the movement of one fluorescent object. The domed base consists of: a base formed with a predetermined observation site and for receiving the main body of the microscope; a dome coupled to and covering the base to define a light-shielding chamber and formed with a transparent observation aperture; and a light source assembly consisting of a plurality of light sources for emitting excitation light at low angles towards the predetermined observation site.

Combining the fluorescence observation device with a partition dome with a fluorescence microscope will form the fluorescence microscope with a partition dome in this case, consisting of: a main body; a base formed with a predetermined observation site for receiving the main body of the microscope; a partition dome set on the base for confining the movement of and observing at least one fluorescent object, the partition dome consisting of: a dome coupled to and covering the base to define a light-shielding chamber and formed with a transparent observation aperture; and a light source assembly consisting of a plurality of light sources for emitting excitation light at low angles towards the predetermined observation site.

The invention provides a fluorescence observation device with a partition dome, base and fluorescence microscope. The base and the dome define a light-shielding chamber to confine the movement of the fluorescent object, so as to eliminate the blind visual angles of the observation device. They can also be removed and cleaned conveniently. The contamination scope is also restrained to relieve the cleaning burden of the researchers, and the possibility of spreading pollutants and germs can be also reduced. In the meantime, it maintains a safe distance between the objective of the inspection device and the fluorescent object. Moreover, it provides a built-in excitation light source at low angles, to resolve the problem of the reflection light covering the fluorescence to be observed, and the large bellow tubes failing to precisely adjust illumination angles. Its application is not just limited to the large experimental animals.

### BRIEF DESCRIPTION OF THE DRAWINGS

FIG. 1 is a sectional schematic diagram of the fluorescence observation device of the invention in the first preferred embodiment, which is used to describe the dispersion of light source and forming of an isolated space;

FIG. 2 is a sectional schematic diagram of the fluorescence observation device of the invention in the second preferred embodiment, which is used to illustrate the light source assembly and the forming of a light-shielding chamber;

FIG. 3 is a block diagram of the base in the embodiment shown in FIG. 2, which is used to illustrate the correlation between the gap and the guide portion;

FIG. 4 is a sectional schematic diagram of the base used in the fluorescence microscope of the invention in the first preferred embodiment, which is used to illustrate how the third type of fluorescence observation device with a partition dome in the case is combined with the base, as well as the structure and correlation among the light source, the light guide element and the steel net;

FIG. 5 is a sectional schematic diagram of the embodiment shown in FIG. 4, illustrating the structure of the transparent observation aperture on the fluorescence observation device;

FIG. 6 is a schematic side view of the embodiment shown in FIG. 4, illustrating the structural position of the gap formed on the dome, which is taken as the guide portion;

FIG. 7 is a schematic side view of the fluorescence microscope in the first embodiment, illustrating how the fluorescence observation device with a partition dome in this case, as an aided tool, is combined with the ordinary optical microscope, to achieve the effect of fluorescence microscope;

FIG. 8 is an enlarged diagram of the partial structure of the embodiment as shown in FIG. 7, which is used to illustrate how LED with adjustable emitting angles works, as well as the structure of the guide portion formed on the base; and

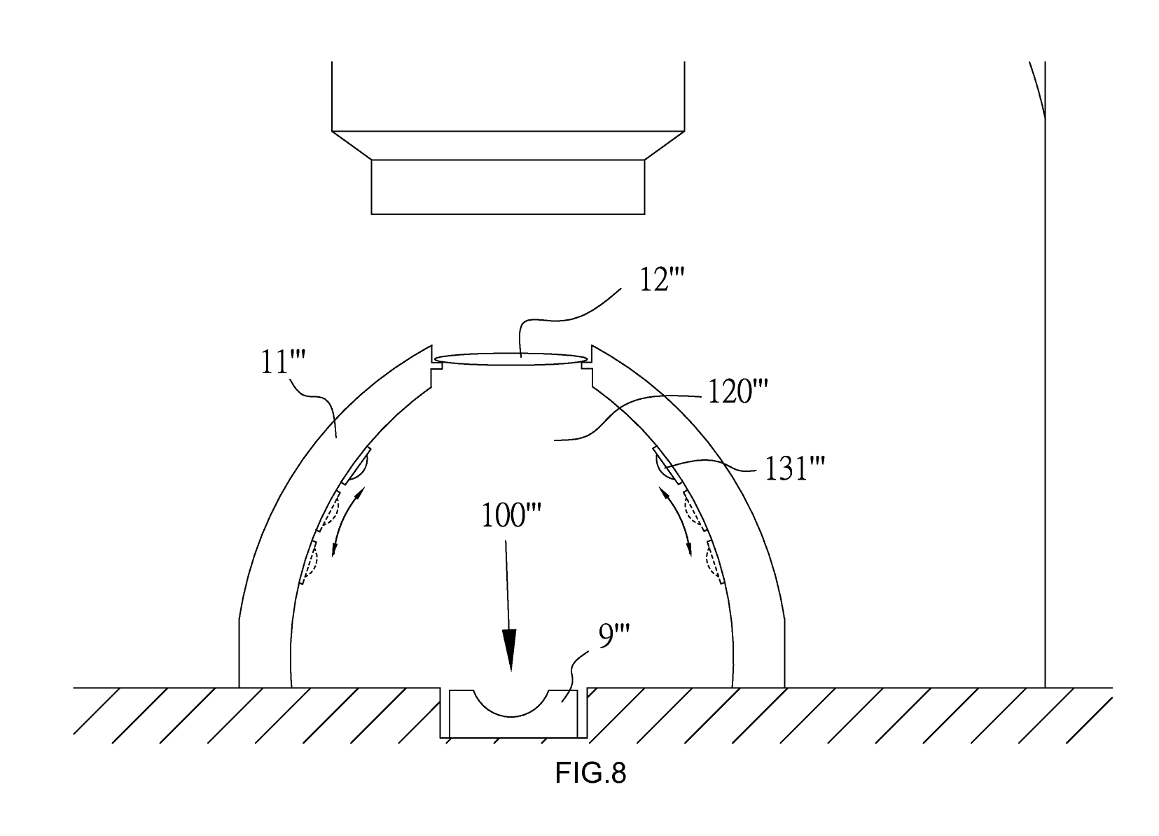

FIG. 9 is an enlarged diagram of the partial structure of the embodiment shown in FIG. 7, which is used to illustrate the structure of the bidirectional guide portion formed on the base.

FIG. 10 illustrates a DIC microscope that can be integrated with, a case according to an embodiment of the invention.

FIG. 11 illustrates another DIC microscope that can be integrated with a case according to an embodiment of the invention.

### DETAILED DESCRIPTION OF THE PREFERRED EMBODIMENTS

The abovementioned and other technical contents, features and benefits related to the invention will be clearly demonstrated the embodiments below with diagrams. The same elements in the embodiments will be represented as similar symbols.

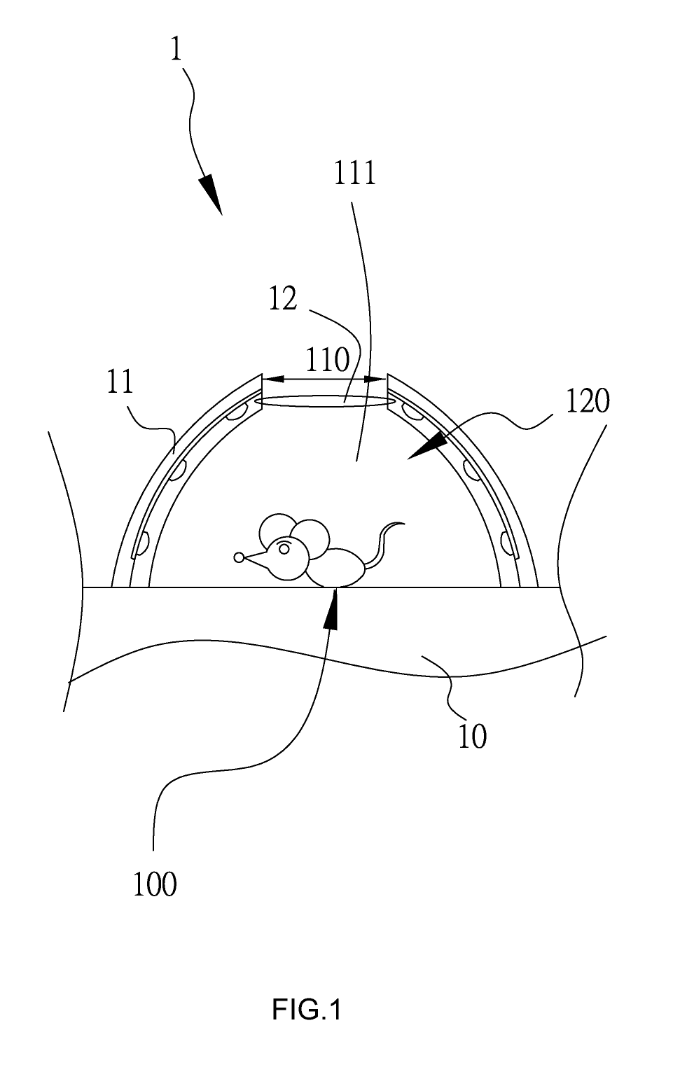

In the first preferred embodiment, the fluorescence observation device 1 of the invention as shown in FIG. 1, includes a base 10 formed with a predetermined observation site 100, which is regarded as the movement area of the fluorescent object on the base 10; and a dome 11 surrounding a light-shielding chamber 111 on the base 10. Since the fluorescence to be observed is usually weak, the case makes use of the light-shielding chamber 111 to shield the external light, and isolate the external noise light to interfere with the observation, so as to increase the S/N ratio.

Furthermore, the light-shielding chamber 111 can also confine the movement area of the fluorescent object, and still leave a transparent observation aperture 110 for observation. However, to prevent the fluorescent object contacting the objective or getting out of the light-shielding chamber 111 through the transparent observation aperture 110, the transparent observation aperture 110 is covered by a removable optical amplifying element, transparent lid 12, such as an acrylic sheet with magnification. This structure forms the status with base 10 on the lower side surrounded by dome 11, and transparent lid 12 on the upper side, which defines an isolated space 120 together. In this way, it effectively confines the movement area of a large fluorescent object, such as an experimental mouse.

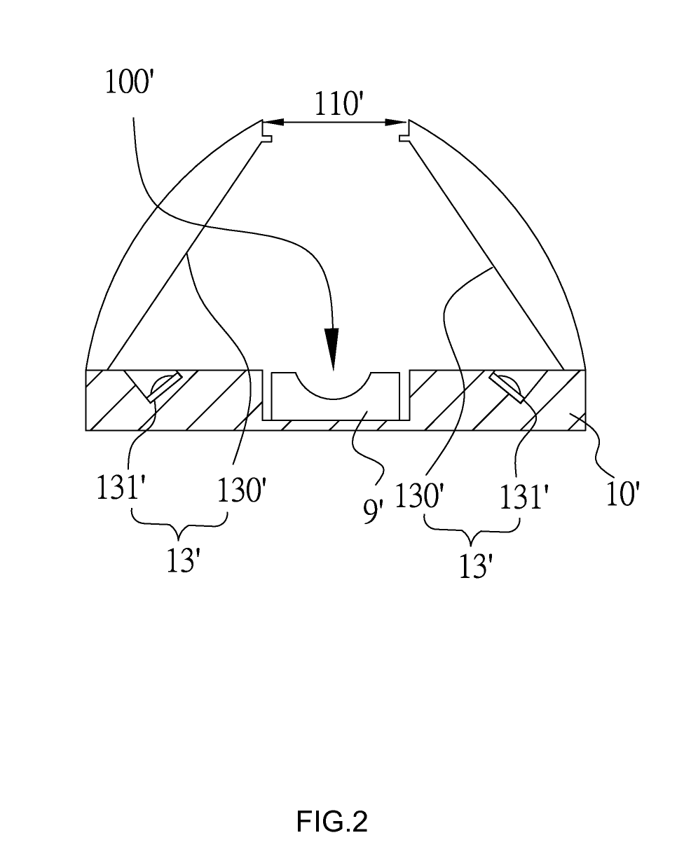

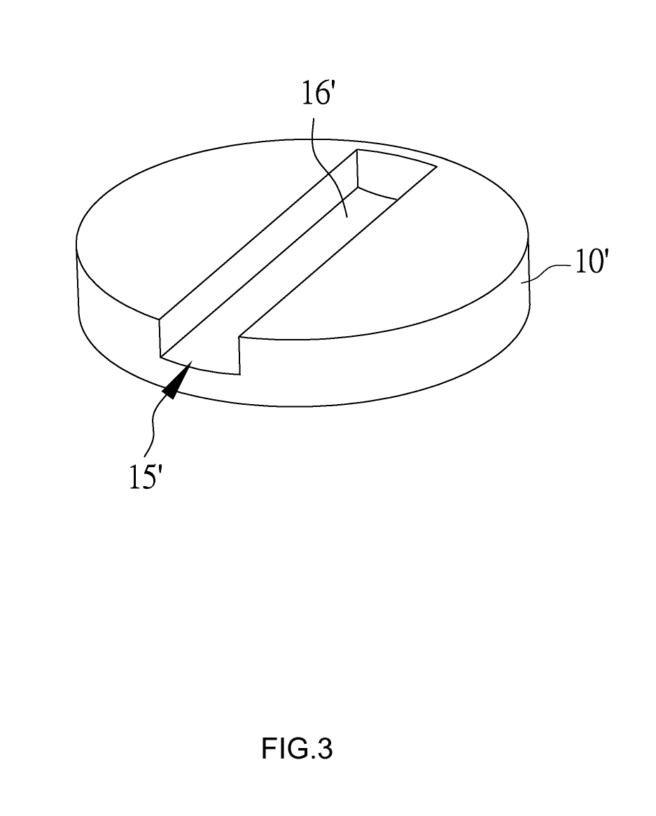

Besides, when observing a tiny experimental object in the support tray, such as a zebrafish, the second preferred embodiment of the fluorescence observation device with a partition dome, as shown in FIG. 2 and FIG. 3, should be used as reference wherein the base 10′ is formed with a gap 15′ and a guide portion 16′ extending in a predetermined direction, which the support tray 9′ can be inserted into the guide portion 16′ along the gap 15′. By doing so, the researcher can observe the small fluorescent object (such as a fluorescent zebrafish) placed on the support tray 9′. The size of gap 15′ is set based on the support tray 9′, wherein the space of the gap 15′ can well hold the support tray 9′, but is too small for the large fluorescent object to get out from gap 15′. The tiny fluorescent object is usually placed on the support tray 9′. After the support tray 9′ is inserted, the only gap 15′ will be blocked. Therefore, it won't cause the fluorescent object getting out from the gap 15′.

The light source assembly 13′ includes light source 131′ composed of a plurality of directivity illumination elements, such as LED. The light source 131′ disposed on base 10′ emits a light beam from the side; the light source assembly 13′ also includes a reflected portion 130′ formed on the inner side of dome 11′, which reflects the light beam from the light source 131′ back to the predetermined observation site 100′ on base 10′. Generally, since the heat conduction space of base 10′ is relatively large, and the material of heat dissipation is flexible, disposing light source 131′ on base 10′ can facilitate the heat dissipation, and reduce the possibility of the fluorescent object being affected by the temperature. Moreover, through the reflection of the light beam at low angles, it prevents the reflection light to go through the transparent observation aperture 110′.

The fluorescent observation device with a partition dome in this invention is a completely independent structure. After the researcher finishes the observation by using the observation device, it can be removed for cleaning separately. In addition, this invention is able to replace the device carrying the fluorescent object. If the researcher puts the fluorescent object in the removed fluorescence observation device, the fluorescent object together with the fluorescence observation device can be carried.

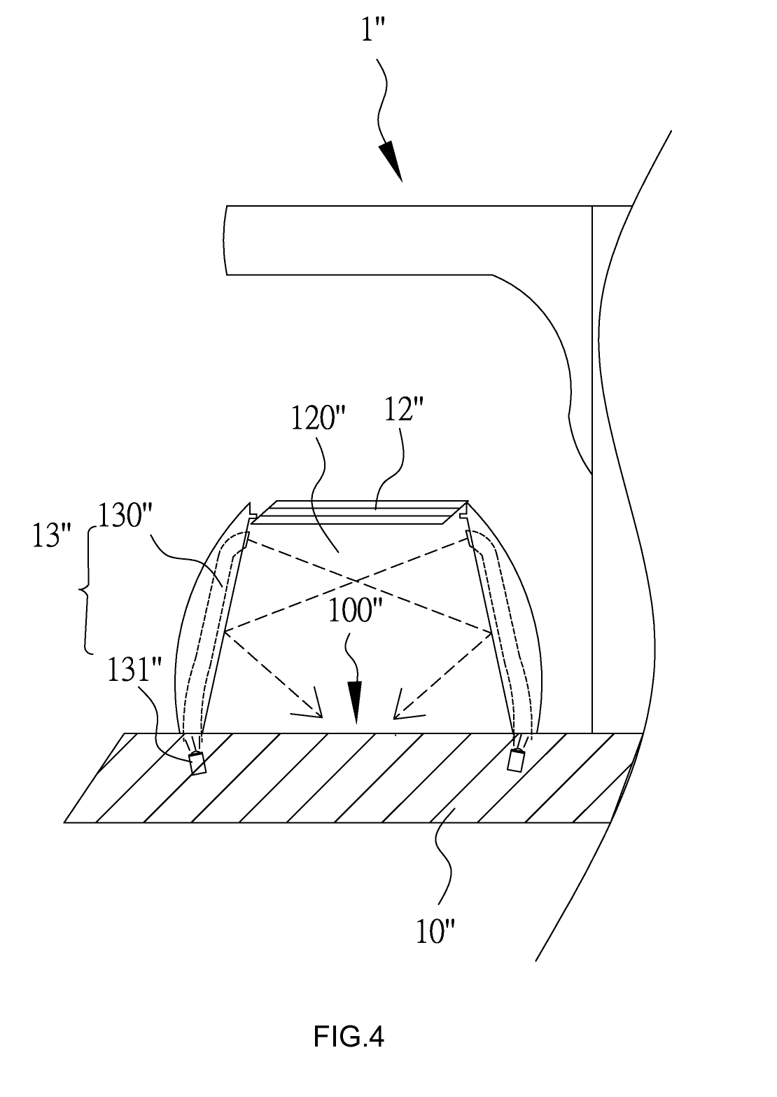

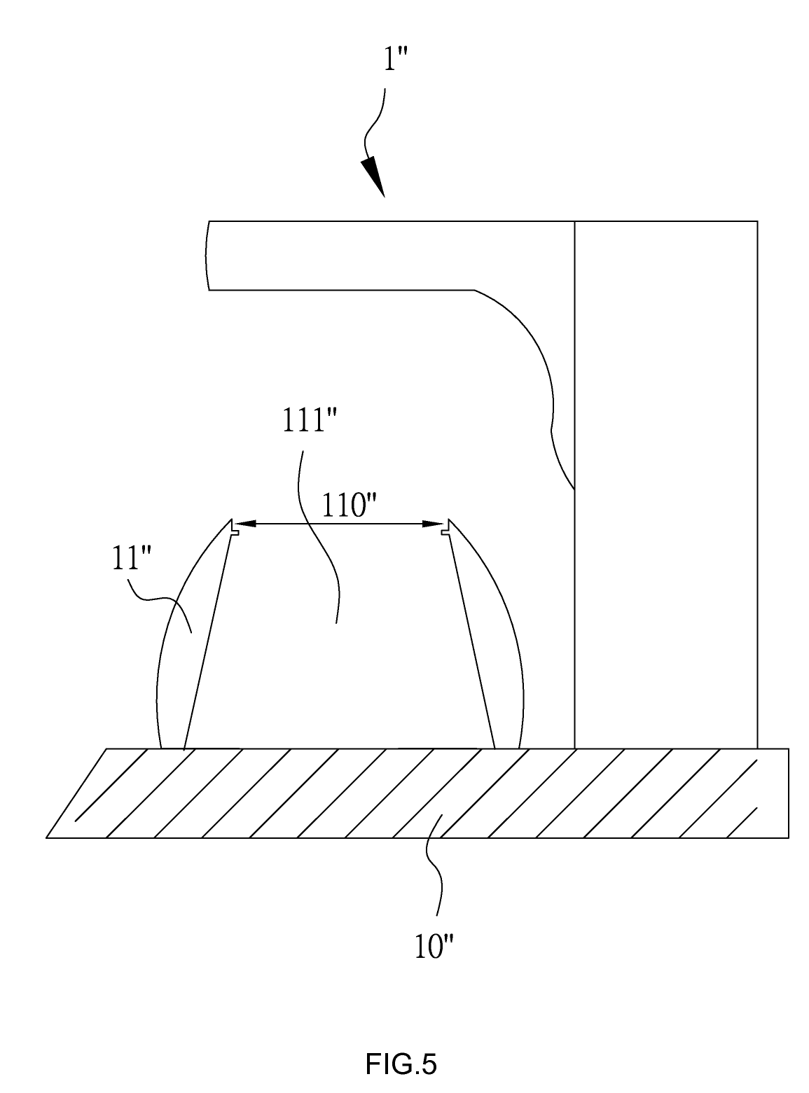

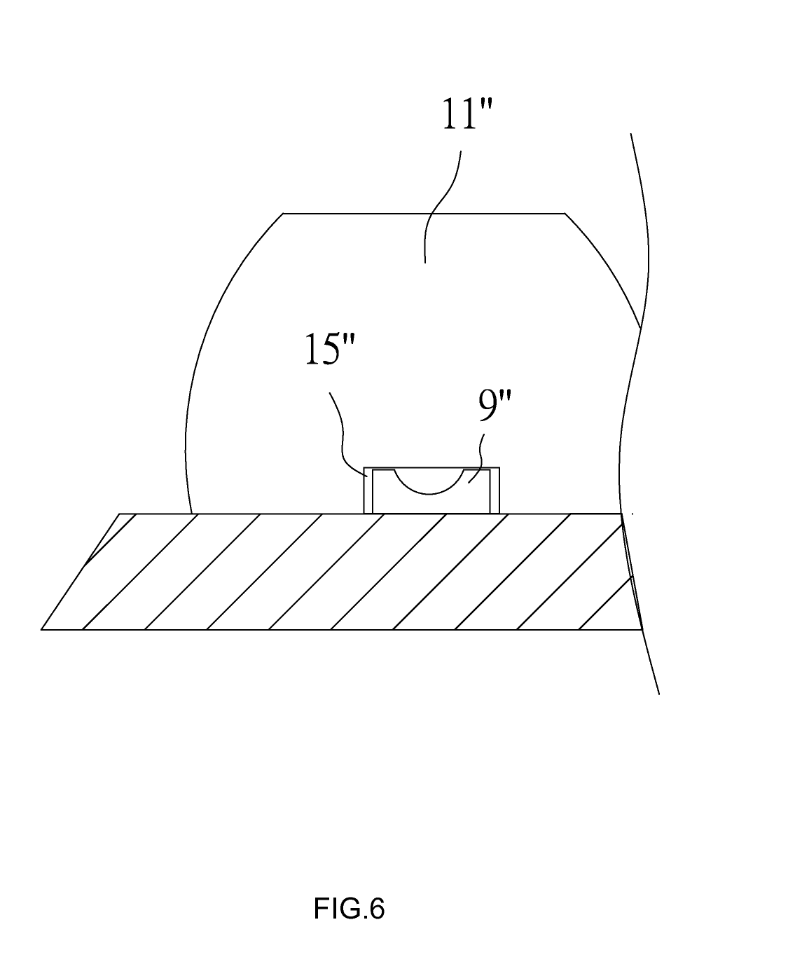

The third preferred embodiment of the invention combines with the fluorescence observation device with a partition dome, as shown in FIG. 4-6, which can integrate with the base for use in the fluorescent microscope of the invention in the first preferred embodiment. In this embodiment, base 1″ includes a base 10″ formed with a movement area for the preset fluorescent object, which is defined as a predetermined observation site 100″. Similarly, dome 11″ defines a light-shielding chamber 111″ on base 10″ to block the external light source, and forms a transparent observation aperture 110″ on the top for observation. Moreover, a transparent lid 12″ which is a steel net in this embodiment covers the transparent observation aperture 110″, forming an isolated space 120″. In this way, it allows the researcher to observe conveniently, and also confines the movement of the fluorescent object.

In addition, a couple of gaps 15″ that are isolated in this case are formed on dome 11″. Support tray 9″ is inserted from one of the two gaps 15″ to the other. After support tray 9″ is inserted, except for the base 10″ on the lower side, the upper and both sides are the space of the light-shielding chamber 111″ without any effect of hindering and confining movement. The purpose of this design is to restrain both ends of support tray 9″ by the two gaps 15″, so the space between these two gaps 15″ also plays as a guide (not presented on the figure). It ensures support tray 9″ extends in a predetermined direction, and prevents support tray 9″ from shaking within the light-shielding chamber 111″, which may cause leakage of the liquid carrying the fluorescent object, deviation of the focus of light source 131″, which can thus affect the analysis.

In this invention, the lighting predetermined observation site 100″ is different as well. The light source assembly 13″ includes light guide element 130″ which is optical fiber in this case, and light source 131″ of the directivity illumination element which is LED in this case. Light source 131″ can be disposed on base 10″ or dome 11″, or even base 1″. The light beam is guided to dome 11″ through the light guide element 130″, and then emitted towards the reflection part 130″ on the opposite side. Finally it is reflected to reach the predetermined observation site 100″. This improvement keeps the light source 131″ far away from the fluorescent object. It also aims at protecting the fluorescent object from the heat produced by light source 131″, which may even cause the death of the fluorescent object, and lower the accuracy and convenience of the experiment. In the meantime, emitting at low angles also prevents the strongest reflection light from going through the transparent observation aperture 110″, which may hinder the observation of the fluorescent object.

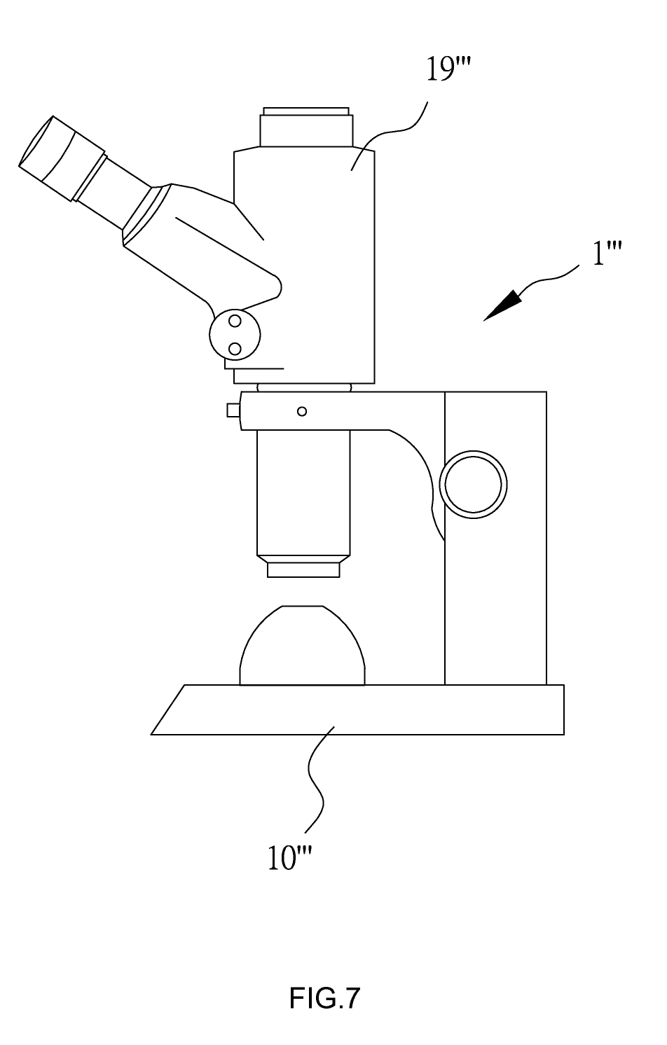

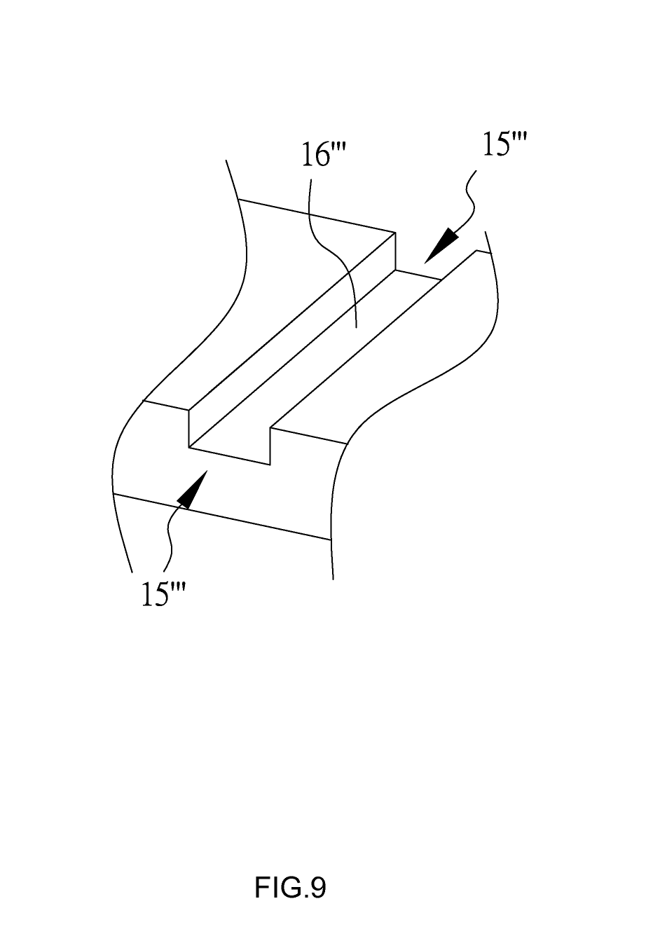

The fourth preferred embodiment of the fluorescence observation device with a partition dome in this invention is as shown in FIGS. 7 and 9. It can integrate with the first preferred embodiment, wherein the main body of the microscope is taken as the fluorescence microscope of this invention. The fluorescence microscope with a partition dome 1′″ includes a base 10″′ and a main body of microscope 19′″, which forms the predetermined observation site 100″′ on the base 10″′ for observation and experiment. The transparent lid 12″′ is a removable optical amplifying element, such as an acrylic sheet with magnification. The transparent lid 12″′, dome 11″′ and base 10″′ define the isolated space 120″′. The light source 131″′ in this invention is the directivity illumination element, such as LED. It is disposed on dome 11″′, with the light beam towards the predetermined observation site 100″′. Moreover, the angle of light source 131″″ is adjustable, which can be moved along dome 11′″ to change the emitting angle of LED as required by the researcher.

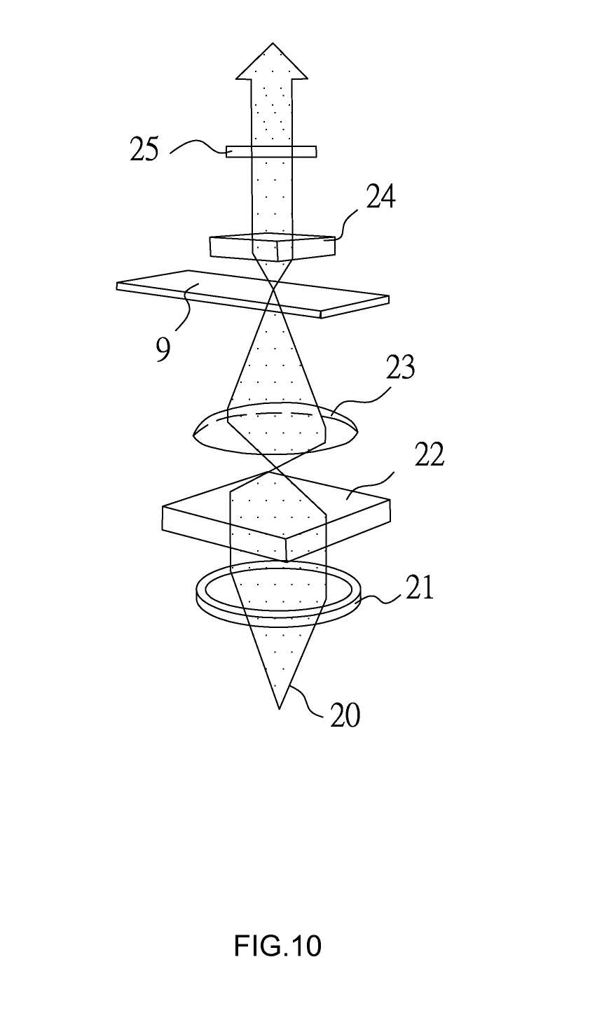

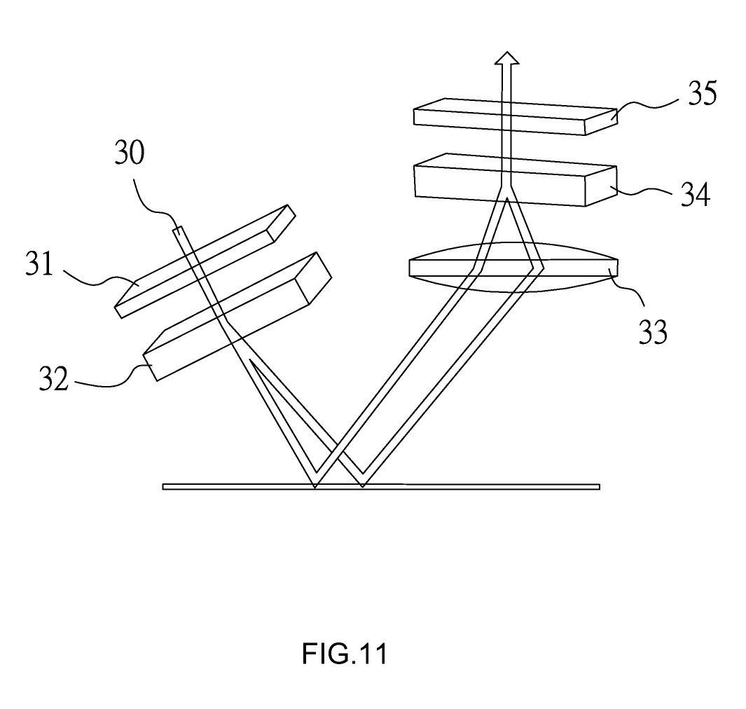

For example, the researcher can elevate the LED within the acceptable range of the luminance of the reflection light, making the light beam meet the current experimental demands. If the researcher thinks the reflection light is too bright to capture the fluorescence, the illumination angle of the LED can be lowered. Moreover, the light source assembly in this case is composed of a plurality of light sources 131″′. You can not only adjust the emitting angle, but also set up LEDs with different central wave lengths. For example, you can set up separate switches for white and ultraviolet LED, or ultraviolet and blue LED, which is flexible for the researcher to adjust the optimal luminance and fluorescence acquisition. Besides, the guide portion 16″′ is still extended along the predetermined direction and formed on base 10″′. Two gaps 15″′ are also formed at the junction of both ends of guide portion 16″′ and the edge of base 10″′, on which the support tray 9″′ can slide towards one direction. The gaps in this case are set for the convenience of illustration. It can be also formed on the base by one half, and on the dome by the other half to form a complete gap.

Wherein, the case can integrate with the DIC microscope shown in FIG. 10. The light beam 20 is emitted upwards, which goes through a polarizer 21, a primary optical device 22 and a concentrator 23, and then reaches the transparent support tray 9. Then it goes through the support tray 9, to the secondary optical device 24 and polaroid analyzer 25, and finally reaches the eyepiece, the camera lens or the researcher's eyes. In addition, it can also apply the DIC microscope shown in FIG. 11. The light beam is emitted from the left of the figure, which goes through a polarizer 31, a primary optical device 32, and then reaches the reflective support tray 9. It is then reflected by the support tray 9 onto a concentrator 33, and then goes through the secondary optical device 34 and polaroid analyzer 35, and finally reaches the eyepiece, the camera lens or the researcher's eyes.

While the invention has been described with reference to the preferred embodiments above, it should be recognized that the preferred embodiments are given for the purpose of illustration only and are not intended to limit the scope of the present invention, and that various modifications and changes, which will be apparent to those skilled in the relevant art, may be made without departing from the spirit and scope of the invention.

What is claimed is:

1. A fluorescence observation device provided with a partition dome for confining the movement of at least one fluorescent object and for observing the at least one fluorescent object, the fluorescence observation device comprising:
a base formed with a predetermined observation site;
a dome coupled to and covering on the base to define a light-shielding chamber and formed with a transparent observation aperture; and
a light source assembly comprising a plurality of light sources for emitting excitation light at low angles towards the predetermined observation site.

2. The fluorescence observation device according to claim 1, further comprising a transparent lid covering the transparent observation aperture, so that the transparent lid, the base and the dome cooperatively define an isolated space.

3. The fluorescence observation device according to claim 1, wherein the fluorescence observation device is adapted to receive a support tray that carries the at least one fluorescent object, and wherein the fluorescence observation device is formed in at least one of the dome and the base with a gap and a guide portion extending in a predetermined direction, along which the support tray can be moved, and wherein the light sources are adapted to emit light towards the predetermined observation site of the base.

4. The fluorescence observation device according to claim 3, wherein the gap comprises two spaced-apart gaps.

5. The fluorescence observation device according to claim 1, wherein the dome is formed at its inner side with a reflection portion for reflecting the light emitted from the light sources towards the predetermined observation site.

6. The fluorescence observation device according to claim 1, wherein the transparent lid is a removable optical amplifying element.

7. The fluorescence observation device according to claim 1, wherein the light sources are directional light sources.

8. A domed base with a partition dome for use in a fluorescence microscope for confining the movement of at least one fluorescent object and for observing the at least one fluorescent object, the domed base comprising:
formed with a predetermined observation site and for receiving a main body of the microscope;
a dome coupled to and covering on the base to define a light-shielding chamber and formed with a transparent observation aperture; and
a light source assembly comprising a plurality of light sources for emitting excitation light at low angles towards the predetermined observation site.

9. The domed base according to claim 8, further comprising a transparent lid covering the transparent observation aperture, so that the transparent lid, the base and the dome cooperatively define an isolated space.

10. The domed base according to claim 8, wherein the domed base is adapted to receive a support tray that carries the at least one fluorescent object, and wherein the domed base is formed in at least one of the dome and the base with a gap and a guide portion extending in a predetermined direction, along which the support tray can be moved, and wherein the light sources are adapted to emit light towards the predetermined observation site of the base.

11. A fluorescence microscope provided with a partition dome, comprising:
a main body;
a base formed with a predetermined observation site and for receiving a main body of the microscope;
a partition dome disposed on the base for confining the movement of at least one fluorescent object and for observing the at least one fluorescent object, the partition dome comprising:
a dome coupled to and covering on the base to define a light-shielding chamber and formed with a transparent observation aperture; and
a light source assembly comprising a plurality of light sources for emitting excitation light at low angles towards the predetermined observation site.

12. The fluorescence microscope according to claim 11, further comprising a transparent lid covering the transparent observation aperture, so that the transparent lid, the base and the dome cooperatively define an isolated space.

13. The fluorescence microscope according to claim 11, wherein the fluorescence microscope is adapted to receive a support tray that carries the at least one fluorescent object, and wherein the fluorescence microscope is formed in at least one of the dome and the base with a gap and a guide portion extending in a predetermined direction, along which the support tray can be moved, and wherein the light sources are adapted to emit light towards the predetermined observation site of the base.
